(19) United States
(12) Patent Application Publication
(10) Pub. No.: US 2026/0105618 A1
(43) Pub. Date: Apr. 16, 2026

(54) Unified Framework for Depth Representation and Figure-Ground Organization

(71) Applicant: Tianlong Chen, Germantown, MD (US)

(72) Inventor: Tianlong Chen, Germantown, MD (US)

(21) Appl. No.: 19/414,278

(22) Filed: Dec. 10, 2025

Related U.S. Application Data
(63) Continuation-in-part of application No. 19/312,316, filed on Aug. 28, 2025.
(60) Provisional application No. 63/743,604, filed on Jan. 9, 2025.

(51) Int. Cl. G06T 7/50; G06T 7/12; G06T 7/136

(52) U.S. Cl. CPC G06T 7/50; G06T 7/12; G06T 7/136

(57) ABSTRACT

The invention discloses a unified computational framework for depth perception and figure-ground organization integrating layered disparity representation, relative-disparity computation, and biologically inspired feedback modulation. A multi-layer disparity structure is constructed incorporating: (i) physical epipolar disparity from binocular or motion geometry, (ii) perceptual-epipolar disparity inferred from context yet epipolar-consistent, and (iii) illusory or non-epipolar disparity arising from Gestalt or category-modulated cues. Directional relative-disparity differencing followed by thresholding produces intrinsic border-ownership polarity, directional selectivity, and early category-consistent structure without requiring contour extraction. Two complementary V4 feedback pathways refine disparity layers and modulate global contextual priors, stabilizing figure-ground interpretation and enabling perceptual multistability. An active-neuron surface filling-in mechanism maintains owner-side continuity and coherent surface representation across layers. Together, the system forms a hierarchical recurrent architecture supporting stable, context-aware depth perception across geometric, ambiguous, and illusory cues.

### CROSS-REFERENCE TO RELATED APPLICATIONS

This application is a Continuation-in-Part (CIP) of
U.S. Utility application Ser. No. 19/312,316, filed Aug. 28, 2025, which claims priority to
U.S. Provisional Application No. 63/743,604, filed Jan. 9, 2025,
   both titled “Layered Disparity Representation and Active Neurons for Enhanced Depth Perception, Border Ownership Generation, and Surface Filling-In.”

The entirety of both applications is incorporated herein by reference.

### FIELD OF THE INVENTION

The invention relates to computer vision, computational neuroscience, depth perception, binocular processing, figure-ground organization, and border-ownership representation. More specifically, it concerns a unified computational framework combining extended depth representations, relative-disparity computation, V4-mediated feedback, category-modulated context integration, and active-neuron surface propagation.

### BACKGROUND OF THE INVENTION

Prior work—including the parent applications—introduced a disparity representation comprising near- and far-range channels and an active-neuron propagation mechanism for figure-ground organization. However, several limitations remained:

Prior depth representations primarily encoded physical (epipolar-geometry) disparity and did not formalize additional depth components such as perceptual-epipolar, illusory, or category-associated depth components.

Earlier border ownership (BO) coding approaches relied on contour extraction and explicit assignment of each border pixel to an owner-side channel, rather than deriving ownership intrinsically from disparity structure.

Prior frameworks incorporated category-selective channels, but did not embed category-dependent contextual biases within an extended disparity structure or explicitly link them to relative-disparity-based border-ownership computation.

Prior frameworks lacked a unified account of perceptual multistability, such as Rubin Face-Vase alternations or Kanizsa depth “pop-out.”

Feedback from V4 was not previously formalized as dual distinct pathways with complementary functions.

Therefore, an improved computational architecture is needed to unify early disparity computation, figure—ground organization, deeper contextual integration, and perceptual dynamics.

### SUMMARY OF THE INVENTION

The present invention provides a unified computational framework for depth and figure—ground organization. The framework integrates layered disparity representation, relative-disparity computation, biologically inspired V4 feedback modulation, and surface-consistency mechanisms into a coherent system that generates intrinsic border ownership, directional selectivity, and stable perceptual organization.

### 1. Extended Layered Disparity Representation

The invention introduces an extended disparity structure comprising multiple explicitly defined depth layers, including:
Physical epipolar disparity (spatial and temporal), derived from binocular geometry or motion cues following epipolar constraints;
Perceptual-epipolar disparity, representing perceptually inferred but epipolar-consistent depth;
Illusory/non-epipolar disparity, including context-driven, Gestalt-induced, and category-modulated disparity components that do not follow epipolar geometry but influence perceived depth.

This layered representation unifies geometric and non-geometric depth cues in a common computational format.

### 2. Feedforward Relative-Disparity (RD) Differencing and Thresholding

A feedforward RD computation mechanism applies directional spatial differencing (row-wise and column-wise) followed by thresholding to produce:
Border-ownership (BO) polarity, identifying the foreground-side of each border;
Directional selectivity, given by the sign of local depth change across the border;
Layer-specific contour activations, enabling contour responses assigned to the appropriate disparity layer;
Early category-selective structure, when illusory or context-driven layers contain category-modulated disparity.

In this mechanism, borders are formed with intrinsic border ownership without requiring contour extraction.

### 3. Dual V4-Based Feedback Modulation

The invention further includes two complementary feedback pathways originating from cortical area V4:
A V4→V1 precision pathway, which re-weights and refines individual disparity layers, sharpens depth discontinuities, suppresses extended, smoothly varying depth regions, and may instantiate or strengthen illusory or context-driven disparity components.
A V4→V2 context pathway, which injects global contextual priors, stabilizes global figure-ground interpretation, supports category consistency, and aligns local RD/BO responses with high-level contextual organization.

These feedback pathways operate subsequent to the feedforward RD computation within each recurrent processing cycle, supplying precision- and context-based modulation that refines the disparity representation and stabilizes figure-ground interpretation across iterations. They thereby support dynamic perceptual stability as well as controlled multistability.

4. System-Level Integration with Active-Neuron Surface Filling-In

The framework incorporates an active-neuron propagation mechanism, previously disclosed in the parent applications and extended herein as part of the unified architecture. This mechanism propagates owner-side signals, maintains surface coherence, and ensures depth-consistent figure-ground organization across disparity layers.

Together, the layered disparity representation, RD-based intrinsic border-ownership computation, dual V4 feedback pathways, and active-neuron surface filling-in form a hierarchical recurrent system capable of producing stable, context-aware depth representations and figure-ground organization across both geometric and non-geometric depth cues.

### BRIEF DESCRIPTION OF THE DRAWINGS

Exemplary embodiments of the present disclosure are illustrated in the accompanying drawings, which are described below and referenced throughout the specification.

FIG. 1 is a schematic diagram illustrating an extended Layered Disparity Representation, illustrating multiple explicit depth-encoding layers including physical (epipolar-geometry) disparity, perceptual-epipolar disparity, and illusory or context-driven disparity components integrated into a unified depth structure.

FIG. 2 is a schematic diagram of a disparity-differencing kernel (referred to as k3.4), showing its spatial sampling layout for computing relative disparity using a broader, oriented receptive-field configuration.

FIG. 3 is a diagram of a disparity-differencing kernel (referred to as k1.5), depicting a more localized sampling configuration for computing fine-scale relative disparity.

FIG. 4 is an illustration of border-owner-side directions on a sample rectangle object, demonstrating how owner-side assignment relates to border orientation and foreground/background configuration.

FIG. 5 is a schematic representation of exemplary relative-disparity-based codings, depicting how relative disparity differencing and thresholding produce orientation-specific border-ownership responses mapped to directional channels.

FIG. 6 shows the performance of a training-free model, TcRd(k1.5), on a sample from the modified Virtual KITTI 2 (VKitti) dataset. The model takes layered disparities as input, applies the k1.5 kernel, and uses RD-sign coding (as in FIG. 5(b)) to produce Near, Far, and summed border-ownership maps.

For clarity of exposition in this specification, border-ownership visualizations may use a two-color scheme (e.g., red for owner-side ‘left/below’ and green for ‘right/above’). This color convention is purely illustrative and is not required for the operation or implementation of the disclosed invention. Patent drawings may depict these relations using grayscale, hatching, or directional indicators instead of color.

FIG. 7 presents examples of perceptual-epipolar and illusory (non-epipolar) disparity perceived from the same 2-D image, illustrating context-dependent depth formation outside strict epipolar geometry.

FIG. 8 presents several Kanizsa figures, their corresponding illusory disparity layers, and the resulting border-ownership maps.

| FIG. 9 is a schematic diagram highlighting the dual V4 feedback pathways—V4→V1 (precision modulation) and V4→V2 (contextual modulation)—as a simplified version of the full system architecture shown in FIG. 10.

FIG. 10 is a schematic system-level architecture diagram illustrating a unified framework for depth representation and figure-ground organization. The figure integrates:
(1) a layered disparity representation comprising physical, perceptual-epipolar, and illusory/context-driven disparity layers;
(2) feedforward relative-disparity differencing and thresholding to generate RD signals, border-ownership polarity, and early category-selective responses;
(3) dual V4 feedback pathways, including a V4→V1 precision pathway for refining disparity layers and a V4→V2 context pathway for stabilizing global figure-ground interpretation and category consistency; and
(4) an active-neuron surface-filling-in mechanism that propagates owner-side signals to maintain coherent surfaces and figure-ground structure.

The figure summarizes the functional relationships among the feedforward operations, layered disparity representation, feedback modulation, and surface-continuity mechanisms within the disclosed unified framework.

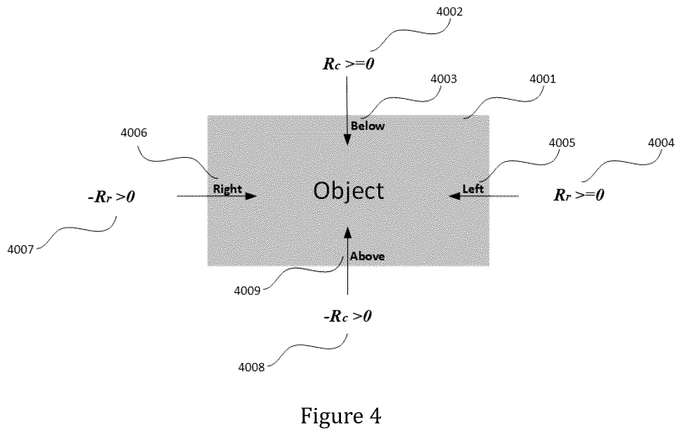

FIG. 11 illustrates complex owner-side direction patterns for more irregular or multi-segment borders. It demonstrates how border-ownership vectors remain consistent with underlying relative-disparity gradients even when object geometry or contour topology deviates from simple rectangular configurations. This figure complements FIG. 4 by showing owner-side determination in curved, branched, or composite contour structures.

### DESCRIPTION OF THE PREFERRED EMBODIMENT

Exemplary embodiments of the invention are shown in the drawings and will be explained in detail in the description that follows.

The present disclosure provides systems and methods for unified depth representation and figure-ground organization based on extended disparity structures, relative-disparity computation, dual feedback modulation, and active-neuron-based surface continuity. The embodiments described herein illustrate exemplary implementations and are not intended to limit the scope of the claims.

### 1. Extended Layered Disparity Representation

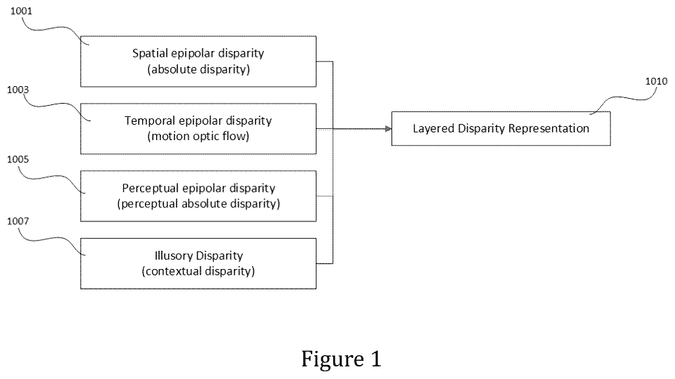

FIG. 1 illustrates an extended Layered Disparity Representation 1010 comprising multiple explicitly defined depth layers. Unlike prior approaches—which primarily encoded only physical (epipolar-geometry) disparity—the disclosed representation integrates several depth components into a unified structure:
(1) Physical Epipolar Disparity 1001/1003
Spatial epipolar disparity 1001, produced by binocular geometry and varying linearly or non-linearly along epipolar lines, such as Near and Far absolute disparities;
Temporal epipolar disparity 1003, derived from motion-based optic flow and representing geometry-consistent temporal depth cues.
(2) Perceptual-Epipolar Disparity 1005
Depth that is perceptually inferred yet remains epipolar-consistent, even when the inference does not arise from strict binocular correspondence (e.g., depth inferred from partial or ambiguous stereo matches).
(3) Illusory/Non-Epipolar Disparity 1007
Disparity components that do not follow epipolar geometry, including
   Gestalt-induced disparity,
   context-driven disparity, and
   category-modulated (category-associated) disparity,
all of which contribute to perceived depth in the absence of physical stereo constraints.

This layered structure serves as the foundational depth representation upon which relative-disparity computation, border-ownership determination, and category-modulated contextual integration are performed.

Each disparity layer is represented as a 2-D disparity map A^{(c)}, where c∈{1, . . . , C} and C is the number of channels. Layers may originate from stereo-matching, monocular inference, perceptual inference, or modulatory feedback. The layered structure enables unified processing of geometric and non-geometric depth cues.

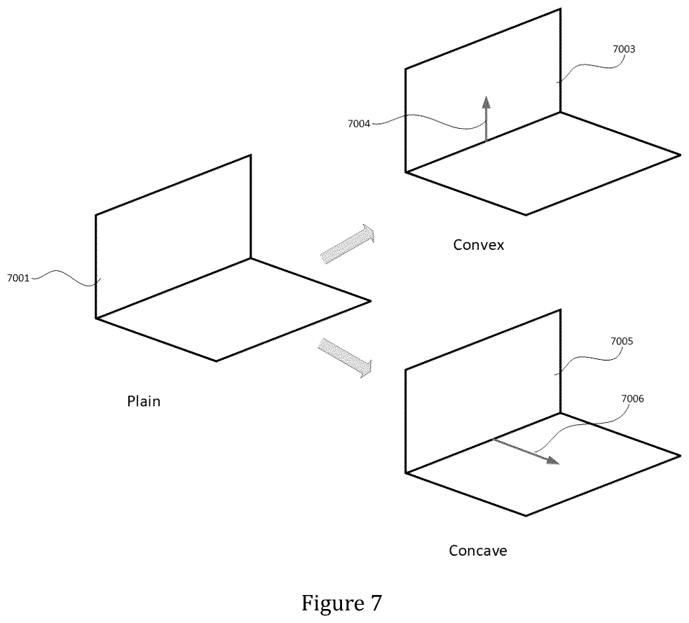

FIG. 7 presents examples of perceptual-epipolar and illusory (non-epipolar) disparity perceived from the same 2-D image 7001, demonstrating how contextual interpretation determines which disparity layer is activated:
No object recognized→No disparity perceived. (7001)
When the image is not interpreted as containing structured surfaces, no depth signal is generated.
Contextual grouping without geometric constraint→Illusory disparity. (7001)
When a surface or figure is perceived solely through contextual grouping, depth is generated in a non-epipolar manner.
Interpretation as a coherent 3-D configuration→Perceptual-epipolar disparity.
Case 7003: The vertical rectangle appears in front of the horizontal rectangle; the shared middle border 7004 is assigned to the vertical rectangle.
Case 7005: The horizontal rectangle appears in front of the vertical rectangle; the shared middle border 7006 is assigned to the horizontal rectangle.

These examples (FIG. 7) illustrate how the same 2-D stimulus can activate different layers-illusory or perceptual-epipolar-depending on contextual interpretation and figure ground organization.

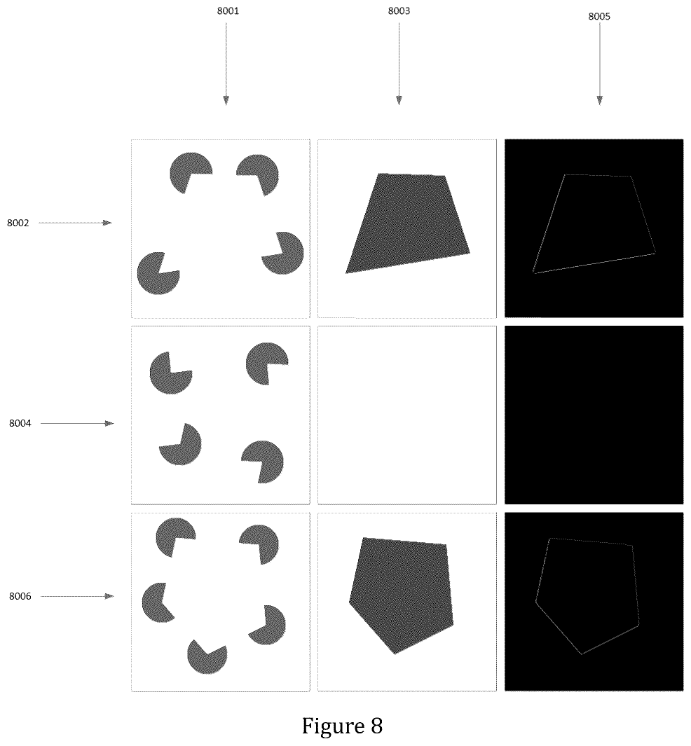

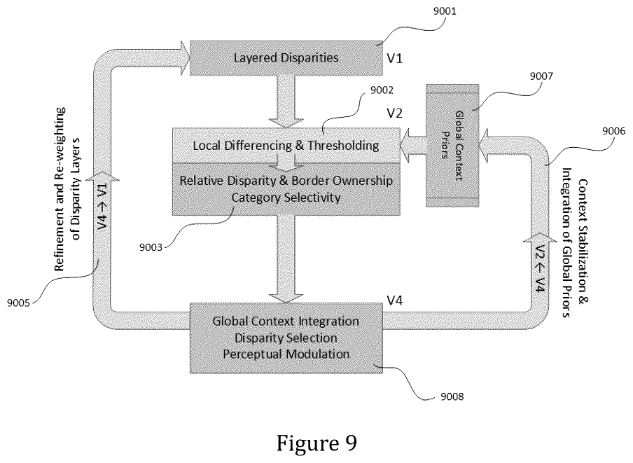

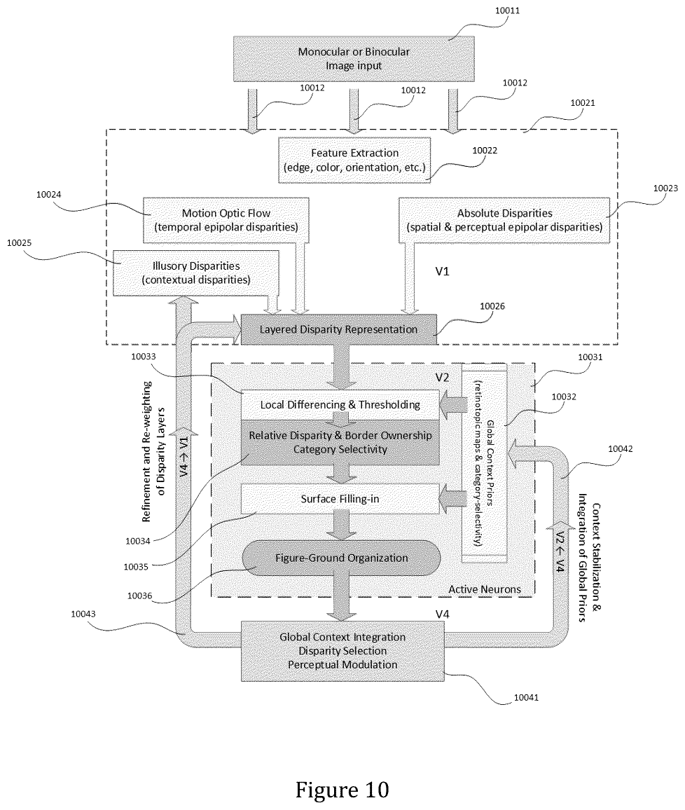

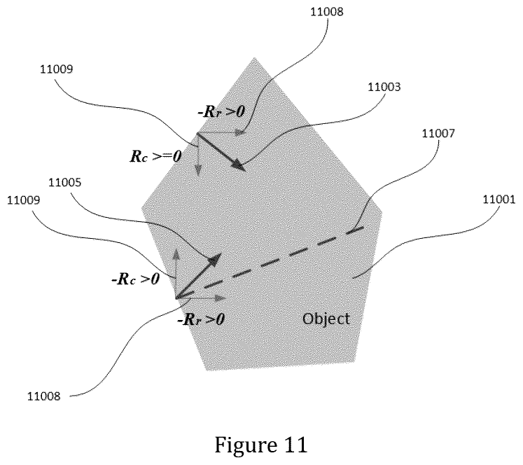

FIG. 8 presents several Kanizsa FIG. 8001 column), their corresponding illusory disparity layers (8003 column), and the resulting border-ownership (BO) maps (8005 column). These examples illustrate how non-epipolar (illusory) disparity emerges from purely contextual and Gestalt configurations in the absence of physical stereo cues.

The middle row (8004) shows a false Kanizsa configuration was generated by rotating end-points by 90°. This manipulation disrupts the perceptual grouping that normally produces an illusory surface. As a result: the illusory disparity layer fails to form a coherent illusory object (8003, middle row), and the resulting BO map (8005, middle row) shows no organized figure-ground structure.

In contrast, the authentic Kanizsa stimuli (8002 and 8006 rows) give rise to: a coherent illusory disparity layer that encodes the perceived illusory object (8003 column, 8002/8006 rows), and BO maps (8005 column, 8002/8006 rows) whose ownership assignments align with the illusory depth relationships.

These examples (FIG. 8) demonstrate how illusory/non-epipolar disparity layers naturally interface with RD-based border-ownership computation, providing a unified treatment of both physical and non-physical depth cues within the disclosed layered disparity framework.

### 2. Local Relative-Disparity (RD) Differencing and Thresholding

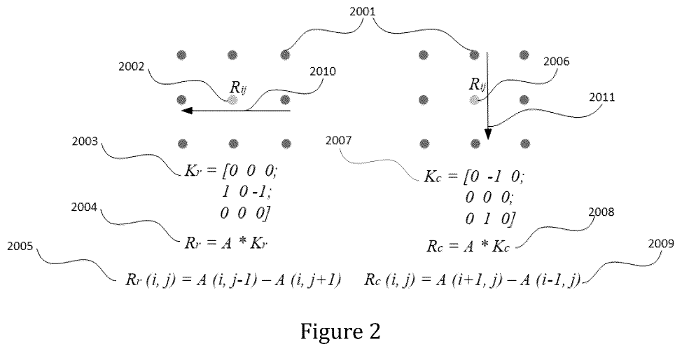

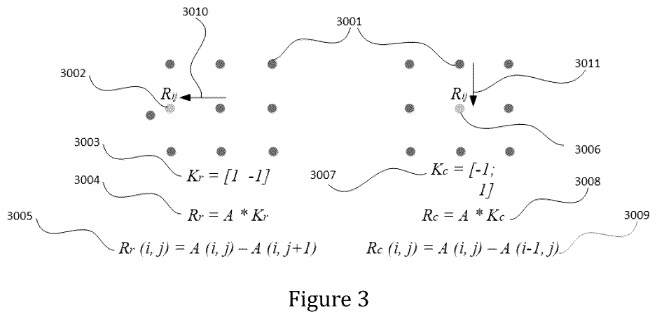

FIGS. 2 and 3 illustrate two exemplary sets (denoted as k3.4 and k1.5) of spatial kernels used to compute relative disparity from Layered Disparity Representation. Each kernel set includes a row kernel Kᵣ (2003, 3003) and a column kernel K_{c} (2007, 3007). Convolution of these kernels with local neighborhoods around the corresponding (gray) pixels (2002, 2006, 3002, 3006) produces row- and column-wise relative-disparity values (2004, 2005, 2008, 3004, 3005, 3008).

While FIGS. 2 and 3 illustrate exemplary fixed spatial differencing kernels (k3.4 and k1.5), the invention is not limited to any particular kernel size or fixed coefficient pattern. In alternative embodiments, the row-wise and column-wise kernels Kᵣ and K_{c} may be:
learned through optimization, trained as part of a neural network,
selected adaptively based on local image structure, or
generated dynamically to enhance disparity sensitivity or noise robustness.

In further embodiments, the system may employ composite kernels formed as linear combinations of Kᵣ and K_{c}, diagonal differencing kernels, or multi-directional learned filters that jointly encode disparity gradients across multiple orientations. Such kernels may substitute for, or operate in addition to, Kᵣ and K_{c} when computing directional relative-disparity values. As used herein, any kernel or filter configured to compute a directed disparity difference suitable for determining sign, magnitude, and owner-side direction is encompassed within the scope of the invention.

For the k3.4 kernel set:

$${K}_{r} = [ \begin{matrix}0 & 0 & 0 \\ 1 & 0 & - 1 \\ 0 & 0 & 0\end{matrix} ] \qquad ( Eq . 4.1 )$$

$${K}_{c} = [ \begin{matrix}0 & - 1 & 0 \\ 0 & 0 & 0 \\ 0 & 1 & 0\end{matrix} ] \qquad ( Eq . 4.2 )$$

For the k1.5 kernel set:

$${K}_{r} = [ \begin{matrix}1 & - 1\end{matrix} ] \qquad ( Eq . 4.3 )$$

$${K}_{c} = [ \begin{matrix}- 1 \\ 1\end{matrix} ] \qquad ( Eq . 4.4 )$$

### Relative Disparity Computation

For each disparity layer A^{(c)} in the Layered Disparity Representation, row-wise and column-wise relative-disparity maps, denoted

$${R}_{r}^{( c )} and {R}_{c}^{( c )} ,$$

are computed by directional spatial differencing:

$${R}_{r}^{( c )} = {K}_{r} * {A}^{( c )} \qquad ( Eq . 4.5 )$$

$${R}_{c}^{( c )} = {K}_{c} * {A}^{( c )} \qquad ( Eq . 4.6 )$$

Where “*” denotes convolution, Kᵣ and K_{c} correspond to the directional kernels shown in either FIG. 2 (k3.4) or 3 (k1.5).

### Thresholding and Border Ownership Vector

Thresholding determines whether the magnitude of a disparity change exceeds a threshold τ. The border-ownership vector at pixel (i, j) is defined as:

$$B O ( i , j ) = [ B {O}_{r} ( i , j ) , B {O}_{c} ( i , j ) ] \qquad ( Eq . 4.7 )$$

with components:

$$B {O}_{r} ( i , j ) = {\sum }_{c = 1}^{C} 1 ( \vert {R}_{r}^{( c )} ( i , j ) \vert > τ ) sgn ( {R}_{r}^{( c )} ( i , j ) ) \qquad ( Eq . 4.8 )$$

$$B {O}_{c} ( i , j ) = {\sum }_{c = 1}^{C} 1 ( \vert {R}_{c}^{( c )} ( i , j ) \vert > τ ) sgn ( {R}_{c}^{( c )} ( i , j ) ) \qquad ( Eq . 4.9 )$$

where 1(⋅) is an indicator function with threshold τ, returning 1 when the condition holds and 0 otherwise; sgn(⋅) denotes the signum function, returning +1 for positive values, −1 for negative values, and 0 otherwise;

$${R}_{r}^{( c )} and {R}_{c}^{( c )}$$

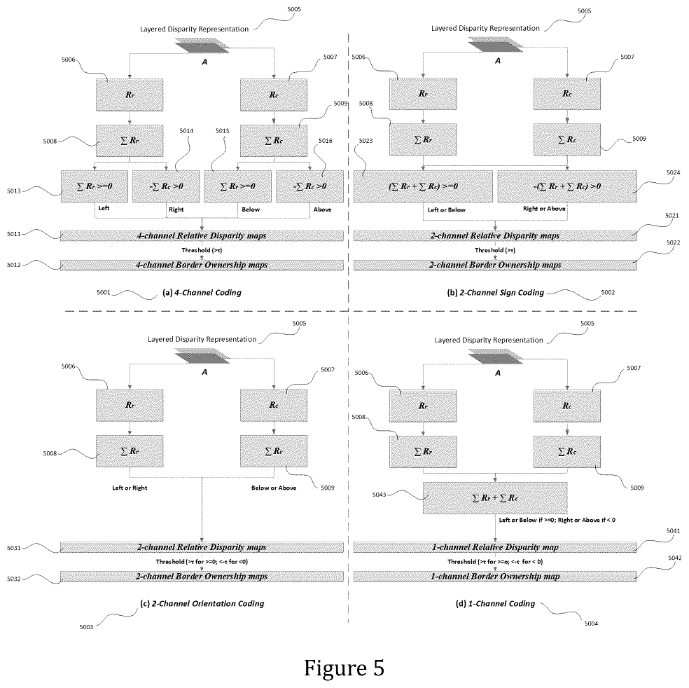

are row- and column-wise relative disparities for layer c; BO(i, j) is the resulting border-ownership vector whose channel organization follows one of the RD/BO coding configurations defined in FIG. 5.

### Channel-Based RD/BO Coding Configurations

FIG. 5 illustrates exemplary channel-based configurations for encoding relative disparity (RD) and border ownership (BO). Each configuration operates on the Layered Disparity Representation 5005 by applying directional kernels 5006 and 5007 to compute row-wise and column-wise relative disparity, followed by thresholding to produce border-ownership responses.

(a) 4-Channel Coding 5001: In this configuration, four distinct channels represent relative disparity 5011 and border ownership 5012 according to orientation and sign: row-positive (‘left’) 5013, row-negative (‘right’) 5014, column-positive (‘below’) 5015, and column-negative (‘above’) 5016. The system produces 4-channel RD maps 5011 and, after thresholding, 4-channel BO maps 5012.

(b) 2-Channel Sign Coding 5002: Here. two channels (2023, 5024) respectively encode the summed contributions of positive and negative disparities across both orientations. The configuration outputs 2-channel RD maps 5021 and corresponding thresholded BO maps 5022.

(c) 2-Channel Orientation Coding 5003: Two channels (5008, 5009) represent row-wise and column-wise relative disparity independently of sign. This results in 2-channel RD maps 5031 and corresponding BO maps 5032.

(d) 1-Channel Coding 5004: A single channel 5043 combines both orientations and signs into one representation, producing a unified RD map 5041 and a thresholded BO map 5042.

In all configurations, the summation (5008, 5009) may alternatively be performed after thresholding (at steps 5012, 5022, 5032, 5042). This preserves the intermediate RD maps for use in depth perception or for downstream processes such as dynamic surface filling-in.

The channels illustrated in FIG. 5 represent border-ownership-oriented channels, not relative-disparity (RD) layers. When accumulation (summation) is performed after thresholding, each border-ownership-oriented channel receives threshold-exceeding contributions from the full set of C relative-disparity layers (or RD-oriented channels), where Cis the number of disparity layers in the Layered Disparity Representation. Thus, the RD computation remains layer-specific, while the final BO channels reflect aggregated, thresholded owner-side contributions derived from all RD layers. Accordingly, each border-ownership-oriented channel is formed by accumulating signed, threshold-exceeding relative-disparity components from all (disparity layers, producing channel-specific border-ownership maps consistent with the selected RD/BO coding configuration.

### Resulting Computational Properties

This computation yields:

(1) Border-ownership polarity: Pixels whose relative disparity magnitude exceeds tare assigned a foreground (near-side) ownership.

(2) Directional selectivity: The sign of

$${R}_{r}^{( c )} or {R}_{c}^{( c )}$$

determines the owner-side direction—i.e., the direction of increasing disparity (4002, 4004, 4007, 4008). FIG. 4 illustrates this for simple horizontal and vertical borders (4003, 4005, 4006, 4009), where the owner-side directions are orthogonal to object borders. FIG. 11 extends this principle to more complex border configurations, showing composed owner-side directions (11003, 11005) that arise from combining the row- and column-wise disparity components (11008, 11009). In such cases, the resulting owner-side vector may not be perfectly orthogonal to the geometric border (e.g., composed direction 11005 relative to orthogonal reference line 11007).

(3) Layer-specific contour activation: Owner-side responses are accumulated across depth layers, enabling multi-depth segmentation.

(4) Early category-selective structure: When the layered representation includes illusory or context-driven layers containing category-modulated disparity, RD thresholding produces category-consistent border signals.

In various implementations, the threshold τ used for determining border-ownership contributions may be fixed, learned from data, or adaptively computed based on local disparity statistics or contextual modulation. The spatial differencing kernels may take alternative sizes, shapes, or orientations, including but not limited to the exemplary k3.4 and k1.5 kernels described above. Furthermore, RD/BO channel mappings may be performed either before or after thresholding, depending on the selected coding configuration, thereby permitting flexible generation of multi-channel border-ownership representations.

FIGS. 4 and 11 jointly illustrate how the sign and magnitude of the relative-disparity components map to owner-side directions in both simple and complex configurations.

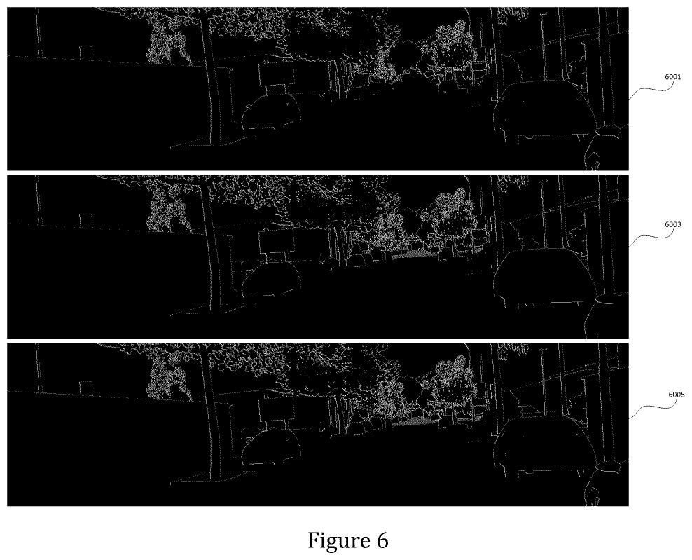

FIG. 6 shows the performance of a training-free model, TcRd (k1.5), on a sample from the modified Virtual KITTI 2 (VKitti) dataset. The model takes layered disparities as input, applies the k1.5 kernel, and uses the 2-Channel (RD) Sign Coding (as in FIG. 5(b) 5002) to produce Near (6001), Far (6003), and summed (6005) border-ownership maps.

Both benchmark evaluations and qualitative inspection indicate that the k1.5 kernel provides an operator that closely matches the formal definition of relative disparity.

### 3. V4-Based Feedback Modulation

FIGS. 9 and 10 illustrate two complementary feedback pathways originating from cortical area V4 (9008 in FIG. 9; 10041 in FIG. 10). These pathways provide distinct yet synergistic forms of top-down modulation that enhance disparity precision, refine contour localization, and stabilize global figure-ground interpretation. Together, they allow the system to integrate precision-based corrections with context-driven perceptual organization and to support dynamic perceptual alternations across multiple stable depth interpretations.

In contrast to the feedforward formation of layered disparity in V1 and the initial relative-disparity differencing and thresholding carried out in V2, the V4 feedback pathways operate as subsequent (rather than concurrent) modulatory stages. Their influence is introduced after the initial feedforward pass, refining and reinforcing perceptual outcomes in the next processing iteration. This delayed feedback structure enables iterative refinement-allowing perceptual interpretations to settle, switch, or stabilize depending on global scene context, prior expectations, and category-level constraints.

### V4→V1 Precision Pathway

(9005 in FIG. 9; 10043 in FIG. 10)

The V4→V1 precision pathway provides targeted modulation of the layered disparity representation (9001 in FIG. 9; 10026 in FIG. 10). Acting upon V1 (10021 in FIG. 10), this pathway:
sharpens depth discontinuities and reduces broad, smoothly varying disparity regions to emphasize depth transitions relevant for figure-ground segregation;
enhances contour precision by amplifying disparity features that correspond to dominant scene interpretations;
instantiates or strengthens non-epipolar, context-driven, or illusory disparity components, reinforcing depth structures that are perceptually inferred rather than strictly geometrically derived;
supports perceptual alternation and multistability (e.g., Rubin Face-Vase, Kanizsa depth reversals) by dynamically re-weighting or re-combining disparity layers across recurrent cycles.

Because V1 constitutes the input to V2's relative-disparity computation stage (9002 in FIG. 9; 10033 in FIG. 10), modulation of V1 by this pathway directly alters the RD/BO signals subsequently produced in V2.

Thus, the V4→V1 pathway indirectly but systematically influences border-ownership polarity, owner-side direction, and early category-selective structure (9003 in FIG. 9; 10034 in FIG. 10), shaping the feedforward computations that determine figure ground segmentation.

### V4→V2 Context Pathway

(9006 in FIG. 9; 10042 in FIG. 10)

The V4→V2 context pathway provides delayed, top-down modulation that operates through global context priors (9007 in FIG. 9; 10032 in FIG. 10). Rather than directly modifying the local RD or BO computations (9002 in FIG. 9; 10033 in FIG. 10), this pathway modulates the contextual priors that govern how V2 integrates and interprets local disparity signals. Through this mechanism, the pathway:
supplies scene-level structure, object continuity, and category-consistency priors that shape how V2 resolves ambiguous or conflicting local cues;
stabilizes figure-ground organization when disparity signals are weak, noisy, or insufficient to determine ownership independently;
ensures that local RD/BO responses become aligned with the global interpretation selected at higher cortical levels, by modulating the priors rather than the computations directly;
supports perceptual stability across time, while still enabling reversals and multistable perceptual states when the global interpretation shifts.

In this framework, the V4→V2 pathway influences border-ownership and category-selective responses indirectly, by shaping the contextual constraints under which V2 integrates local relative-disparity signals (9002 in FIG. 9; 10033 in FIG. 10). This preserves the computational autonomy of the feedforward RD mechanism while enabling global consistency across the visual field.

Taken together, the V4→V1 and V4→V2 pathways create a hierarchical recurrent architecture in which precision refinement and context integration act in complementary, sequential fashion. The V4→V1 pathway enhances the fidelity of the layered disparity representation, improving the depth signals upon which relative-disparity differencing operates. The V4→V2 pathway modulates global-context priors (as illustrated in FIGS. 9 and 10), which in turn influence how V2 integrates local disparity inputs into border-ownership and category-selective outputs. Through this coordinated modulation, the dual-pathway configuration supports stable perceptual interpretation, enables controlled perceptual multistability when multiple interpretations are possible, and enforces context-aware figure-ground organization across iterations of the feedforward-feedback cycle.

### 4. System-Level Integrated Framework for Depth Perception and Figure-Ground Organization

FIG. 10 summarizes the unified system framework. The disclosed architecture integrates:
a layered disparity representation (10026) comprising spatial and perceptual-epipolar disparities (10023), temporal epipolar disparities (10024), and illusory or non-epipolar disparity layers (10025). Spatial and temporal epipolar disparities jointly form the physical epipolar disparity components.
feedforward relative disparity RD differencing and thresholding (10033) that compute relative disparity, border-ownership polarity, directional selectivity, and early category-consistent structure (10034);
dual V4 feedback providing
   precision refinement (10042) and
   context-driven modulation of global scene interpretation and category consistency (10043); and
   active-neuron surface filling-in (10035)—previously disclosed in the parent applications and incorporated herein by reference—which propagates owner-side signals to generate coherent surfaces and maintain depth-consistent figure-ground continuity.

Together, these components provide a coherent, computationally integrated solution for depth perception (10034) and figure-ground organization (10035).

Within this integrated architecture, the newly disclosed disparity extensions, the RD-based feedforward ownership mechanism, and the V4-mediated feedback pathways collectively shape and refine the inputs delivered to the active-neuron surface filling-in module.

While the active-neuron mechanism itself is not newly claimed here, its interaction with the extended disparity structure and dual-pathway feedback enables improved surface coherence, more stable perceptual interpretations, and a unified, depth-driven figure-ground organization that operates across both geometric and non-geometric depth cues.

Although the present invention has been described with reference to certain exemplary and preferred embodiments, the invention is not limited to the specific details set forth herein. Various modifications, substitutions, and alterations will be apparent to those of ordinary skill in the art in view of the foregoing description. All such variations are intended to fall within the scope and spirit of the invention as defined by the appended claims.

What is claimed is:

1. A computer-implemented method, executed by one or more processors, for computing relative disparity and border-ownership at pixels of an input image, the method comprising:
(a) receiving a plurality of disparity layers, each disparity layer comprising a two-dimensional disparity map A^{(c)}, where c∈{1, . . . , C} and C is a number of said disparity layers;
(b) computing, for each disparity layer A^{(c)}:
1) a row-wise relative-disparity map
$${R}_{r}^{( c )} = {K}_{r} * {A}^{( c )} ,$$
obtained by convolving the disparity layer with a first spatial differencing kernel Kᵣ; and
2) a column-wise relative-disparity map
$${R}_{c}^{( c )} = {K}_{c} * {A}^{( c )} ,$$
obtained by convolving the disparity layer with a second spatial differencing kernel K_{c};
(c) applying, for each pixel (i, j), a magnitude threshold τ to the relative-disparity values such that a relative-disparity component is treated as a border-ownership contributor when
$$\vert {R}_{r}^{( c )} ( i , j ) \vert > τ or \vert {R}_{c}^{( c )} ( i , j ) \vert > τ ;$$
(d) determining, for each contributing relative-disparity value at the pixel (i, j), a sign
$$sgn ( {R}_{r}^{( c )} ( i , j ) ) , sgn ( {R}_{c}^{( c )} ( i , j ) ) ,$$
indicating a direction of increasing disparity corresponding a foreground owner-side;
(e) accumulating, for each pixel (ij), signed and thresholded relative-disparity contributions across all disparity layers to obtain border-ownership components
$$B {O}_{r} ( i , j ) = {\sum }_{c = 1}^{C} 1 ( \vert {R}_{r}^{( c )} ( i , j ) \vert > τ ) sgn ( {R}_{r}^{( c )} ( i , j ) ) ,$$
$$B {O}_{c} ( i , j ) = {\sum }_{c = 1}^{C} 1 ( \vert {R}_{c}^{( c )} ( i , j ) \vert > τ ) sgn ( {R}_{c}^{( c )} ( i , j ) )$$
where 1(⋅) is an indicator function with threshold τ, returning 1 when the condition holds true and 0 otherwise;
(f) producing a border-ownership vector for each pixel,
$$B O ( i , j ) = [ B {O}_{r} ( i , j ) , B {O}_{c} ( i , j ) ] ,$$
where the border-ownership vector identifies (i) whether a pixel is a border pixel and (ii) a foreground owner-side direction determined by a sign of increasing relative disparity.

2. A computer-implemented method, executed by one or more processors, for depth perception and figure-ground organization, comprising:
(a) receiving a layered disparity representation comprising a plurality of disparity layers, the disparity layers including physical epipolar disparity, perceptual-epipolar disparity, and illusory or non-epipolar disparity layers;
(b) computing directional relative-disparity values for said layered disparity representation by applying a row-wise spatial differencing kernel Kᵣ and a column-wise spatial differencing kernel K_{c}, respectively;
(c) applying a threshold to said directional relative-disparity values to determine border-ownership polarity and owner-side direction at each pixel;
(d) generating border-ownership and early category-selective outputs by accumulating signed, thresholded relative-disparity contributions across the plurality of disparity layers;
(e) applying V4→V1 precision feedback to refine the layered disparity representation, the V4→V1 feedback including re-weighting, sharpening, instantiating or strengthening selected disparity layers;
(f) applying V4→V2 contextual feedback to modulate contextual priors that guide integration and interpretation of local relative-disparity and border ownership in V2, thereby stabilizing global figure-ground interpretation and enforcing category consistency; and
(g) propagating ownership along owner-side directions using an active-neuron surface filling-in mechanism to generate coherent surfaces and depth-consistent figure-ground organization.

3. A computer-implemented system for depth representation and figure-ground organization, the system comprising:
(a) a layered disparity representation comprising a plurality of disparity layers including physical epipolar disparity, perceptual-epipolar disparity, and illusory or non-epipolar disparity;
(b) a relative-disparity (RD) differencing module configured to compute directional relative disparity by applying a row-wise spatial differencing kernel Kᵣ and a column-wise spatial differencing kernel K_{c} to said plurality of disparity layers;
(c) a thresholding module configured to determine border-ownership polarity and owner-side direction from signed relative-disparity components whose magnitudes exceed a threshold;
(d) a dual-pathway feedback module comprising:
1) a V4→V1 precision-modulation pathway configured to refine, re-weight, sharpen, or instantiate disparity layers; and
2) a V4→V2 context-modulation pathway configured to provide global contextual priors and category-consistent modulation to the computation of relative disparity, border ownership and surface filling-in; and
(e) an active-neuron surface filling-in module configured to propagate ownership along owner-side direction to produce coherent surfaces and depth-consistent figure-ground organization.

4. The method of claim 1, wherein the first and second spatial differencing kernels Kᵣ and K_{c} comprise:
1) a 1×2 kernel [1−1] and a 2×1 kernel
$$[ \begin{matrix}- 1 \\ 1\end{matrix} ] ,$$
respectively; or
2) oriented 3×3 kernels having nonzero elements arranged to measure disparity gradients across and orthogonal to object borders; or
3) one or more adaptive, learned, or composite spatial differencing kernels, including kernels formed as linear combinations of Kᵣ and K_{c}, diagonal or multi-directional kernels, or kernels whose coefficients are learned through optimization or selected based on local image structure.

5. The method of claim 1, wherein the magnitude threshold tis a fixed constant, a learned parameter, or an adaptive threshold determined from local disparity statistics.

6. The method of claim 1, further comprising generating a multi-channel relative-disparity/border-ownership (RD/BO) representation using one of the RD/BO coding configurations described herein, including:
1) a 4-channel coding configuration separating row-positive, row-negative, column-positive, and column-negative components;
2) a 2-channel sign coding configuration separating positive and negative signed relative-disparity components;
3) a 2-channel orientation coding configuration separating row-wise and column-wise components; or
4) a 1-channel coding configuration combining all components into a single unified map,
wherein each configuration specifies how row-wise and column-wise relative-disparity components are accumulated into channel-specific border-ownership maps.

7. The method of claim 1, wherein the plurality of disparity layers comprise at least one of:
1) physical epipolar disparity,
2) perceptual-epipolar disparity, and
3) illusory or non-epipolar disparity.

8. The method of claim 1, wherein border-ownership vectors are computed without requiring prior contour extraction, edge detection, or explicit segmentation of object boundaries.

9. The method of claim 2, wherein the plurality of disparity layers comprises at least one of:
1) spatial epipolar disparity derived from binocular geometry;
2) temporal epipolar disparity derived from motion-based optic flow;
3) perceptual-epipolar disparity inferred from context; and
4) illusory or non-epipolar disparity including Gestalt-induced or category-modulated depth.

10. The method of claim 2, wherein the row-wise and column-wise spatial differencing kernels comprise:
1) a 1×2 kernel and a 2×1 kernel
$$[ \begin{matrix}- 1 \\ 1\end{matrix} ] ,$$
or
2) oriented 3×3 kernels configured to measure disparity gradients across and orthogonal to borders, or
3) adaptive, learned, or composite kernels, including diagonal or multi-directional disparity-gradient filters or linear combinations of Kᵣ and K_{c}.

11. The method of claim 2, wherein applying V4→V1 precision feedback further comprises:
1) suppressing smoothly varying depth regions;
2) enhancing depth discontinuities; and
3) instantiating or strengthening illusory or non-epipolar disparity layers consistent with a preferred global perceptual interpretation.

12. The method of claim 2, wherein applying V4→V2 contextual feedback further comprises modulating global contextual priors that influence integration of relative disparity and affect subsequent surface filling-in.

13. The method of claim 2, wherein the combined effects of V4→V1 and V4→V2 feedback support perceptual multistability by re-weighting disparity layers corresponding to alternative depth organizations over successive recurrent cycles.

14. The method of claim 2, wherein propagating ownership using the active-neuron surface filling-in mechanism comprises:
1) propagating owner-side signals along contour directions defined by the signed relative-disparity values; and
2) maintaining surface continuity across disparity layers during changes in contextual priors or feedback modulation.

15. The method of claim 2, further comprising generating a multi-channel relative-disparity/border-ownership representation according to a selected RD/BO coding configuration, the coding configuration comprising any of:
1) a 4-channel coding configuration separating row-positive, row-negative, column-positive, and column-negative components;
2) a 2-channel sign-coding configuration separating positive and negative signed relative-disparity components;
3) a 2-channel orientation-coding configuration separating row-wise and column-wise components; or
4) a 1-channel coding configuration combining all components into a single unified map,
wherein each configuration specifies how row-wise and column-wise relative-disparity components are accumulated into channel-specific border-ownership maps.

16. The system of claim 3, wherein each module is implemented on one or more processors selected from a CPU, GPU, neural accelerator, or dedicated vision processor.

17. The system of claim 3, wherein the layered disparity representation comprises at least one of:
1) spatial epipolar disparity derived from binocular geometry;
2) temporal epipolar disparity derived from motion-based optic flow;
3) perceptual-epipolar disparity inferred from context; and
4) illusory or non-epipolar disparity including Gestalt-induced or category-modulated depth.

18. The system of claim 3, further comprising a channel-coding module configured to generate a multi-channel relative-disparity/border-ownership representation according to a coding configuration selected from:
1) a 4-channel orientation-and-sign coding configuration separating row-positive, row-negative, column-positive, and column-negative components,
2) a 2-channel sign coding configuration separating positive and negative signed relative-disparity components,
3) a 2-channel orientation coding configuration separating row-wise and column-wise components, or
4) a 1-channel coding configuration combining all components into a single unified map.

19. The system of claim 3, wherein the active-neuron surface filling-in module propagates owner-side information along contours defined by relative-disparity direction and preserves surface continuity across disparity layers.

20. The system of claim 3, wherein:
1) the V4→V1 precision-modulation pathway refines and sharpens disparity layers; and
2) the V4→V2 context-modulation pathway modulates global contextual priors that influence relative-disparity computation, border-ownership determination, and surface filling-in.
